(19) United States
(12) Patent Application Publication
(10) Pub. No.: US 2008/0140913 A1
(43) Pub. Date: Jun. 12, 2008

(54) Storage Device With 1394 Interface

(76) Inventors: Huan-Hui Chiang, Pingzhen City (TW); Hung-Yuan Chen, Pingzhen City (TW)

Correspondence Address: LIN & ASSOCIATES INTELLECTUAL PROPERTY, INC., P.O. BOX 2339, SARATOGA, CA, 95070-0339, US

(21) Appl. No.: 11/567,745

(22) Filed: Dec. 7, 2006

(51) Int. Cl. G06F 12/00; G06F 12/02

(52) U.S. Cl. 711/103; 711/154; 711/E12.008; 711/E12.001

(57) ABSTRACT

A storage device with a 1394 interface is disclosed herein, which receives an accessed command from a host to access data. Herein, the storage device with the 1394 interface comprises at least a 1394 physical layer, a storage module and a controller. After the 1394 physical layer of the storage device is inserted into a corresponding interface of the host, the storage device is electrically connected to the host. Then, the controller can receive a write command, a read command and an erase command from the host through the 1394 physical layer. According to the commands, the data can be written into the storage module, or read and erased from the storage module.

### BACKGROUND OF THE INVENTION

1. Field of the Invention

The present invention generally relates to a storage device, and in particular to a storage device with a 1394 interface.

2. The Prior Arts

Hard disk drives are a large capacity storage device generally used in computers. With the technical development on the hard disk drives, either capacity or price has satisfied customers. However, when accessing data, the read-and-write heads of the hard disk drives have to substantially contact with the magnetic disks, which result in the damage of the magnetic disks and the lose of the data stored in the hard disk drives accordingly.

Moreover, because the hard disk drive has to drive the magnetic disks by a motor with high-speed rotation, the power consumption becomes a problem. It is even a big problem for portable devices such as notebook computers that require low power consumption.

Among the storage devices like the hard disk drives, the flash memories have the most potential to be developed. The flash memories are mainly formed of a plurality of transistor memory cells. The data can be stored or deleted via Fowler-Nordheim tunnel. When accessing data, a large electric current flows through a dielectric layer on a side of a floating gate (FG) in the transistor memory cells. Accordingly, after the transistor memory cells are operated in write or erase data up to a limit times, failures or mistakes occur. Although the failures and mistakes may occur after 100,000-10,000,000 times of the data write/erase operation, many manufacturers still make efforts on improvement of extending the life span of the storage device.

Except the aforementioned drawbacks, the conventional hard disk drive is also inconvenient to be disassembled from the computer. Although an external hard disk box is designed to solve this problem, the hard disk drive entirely enclosed in the box has a heat dissipation problem. Therefore, the external storage devices currently adopt an external interface.

The external interface includes print ports with a low transfer speed, USB 2.0 with a high transfer speed, or the IEEE 1394 that even has a transfer speed of up to 1 Gbps.

The obvious difference between the USB and the IEEE 1394 is the different transfer rate. In the past, the IEEE 1394 was used to transfer files because its flow rate is 100 times faster than USB 1.1. The transfer rate of the USB is 12 Mbps/s, which can be merely connected with Keyboards, Mouse and Microphones. In the other hand, the transfer rate of the IEEE 1394A could reach 400 Mbap/s, which can be connected with Digital Cameras, Scanners and Information Appliances. Despite the USB 2.0 is proposed later to compete with the IEEE 1394A, the flow rate of the IEEE 1394B and the IEEE 1394C can be even increased to 1 G

The USB and the IEEE 1394 have also different structures. The USB needs at least a computer host and a HUB in connection with devices. The whole network can connect at most 127 devices together. However, the IEEE 1394 does not need a computer host and a HUB to connect with the devices. One IEEE 1394 can connect with up to 63 devices. And the IEEE 1394 can link with other IEEE 1394 networks via network bridges, so that more devices can be connected together.

Besides, the IEEE 1394 networks can be reset when the numbers of the devices increase or decrease. The USB detects the change of the number of devices through the HUB. Nowadays, the USB has been widely used and the motherboards of most PC have USB interface. The USB 2.0 with higher transfer speed will be widely applied in the future. The IEEE 1394 is only applied on audio, video and other multimedia devices now.

In a word, due to the external characteristics and the wide bandwidth of the IEEE 1394, the IEEE 1394 coupled with the flash memories even the magnetic disks indeed can replace the hard disk drives.

### SUMMARY OF THE INVENTION

A primary objective of the present invention is to provide a storage device with a 1394 interface, which can access data on a storage module through a 1394 physical layer with high transfer speed, according to a command from a host.

Based on the objective above, the storage device with a 1394 interface in accordance with present invention comprises at least a PCB, a 1394 physical layer, a storage module and a controller. After the 1394 physical layer is inserted into a corresponding interface of the host, the storage device with the 1394 interface is electrically connected with the host. The controller can receive a write command, a read command and an erase command from the host through the 1394 physical layer. According to the commands, the data can be written into the storage module or be read and erased from the storage module.

The advantages and spirit of the present invention may be further described according to the following drawings and detailed description.

### BRIEF DESCRIPTION OF THE DRAWINGS

FIG. 1 is a schematic view showing a storage device with a 1394 interface in accordance with present invention.

FIG. 2 is a schematic view showing a storage module in accordance with present invention.

FIG. 3 is a schematic view showing a storage device with a 1394 interface in accordance with another embodiment of present invention.

### DETAILED DESCRIPTION OF THE PREFERRED EMBODIMENT

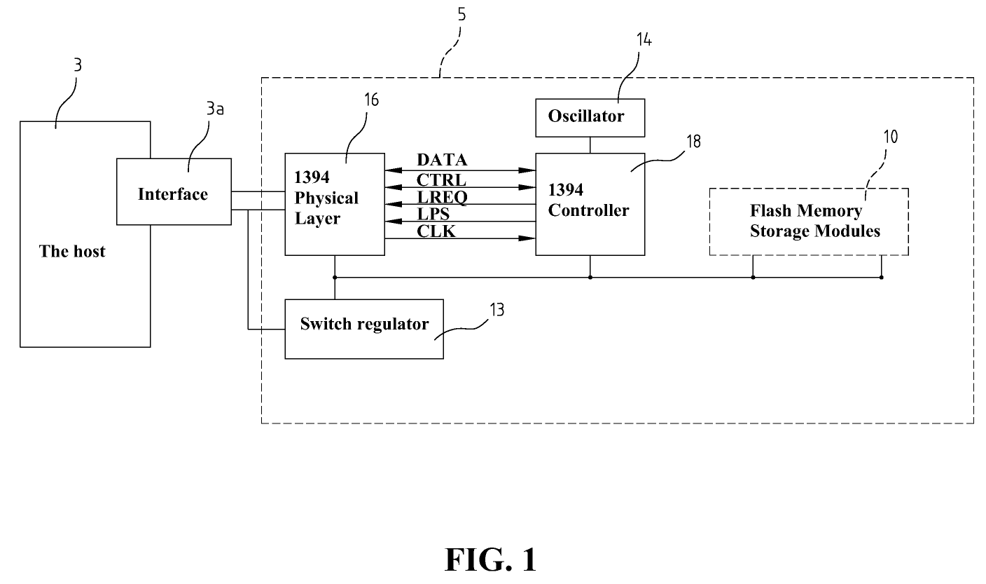

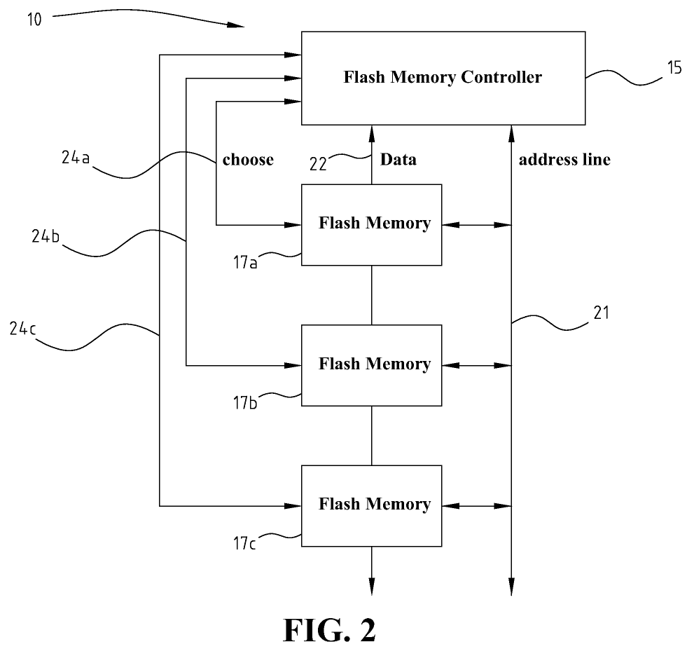

With reference to FIG. 1, a storage device with a 1394 interface in accordance with the present invention comprises a PCB (not shown), a 1394 physical layer 16 mounted on the PCB, a switch regulator 13, a controller 18 for receiving a command from a host 3 to access data, an oscillator 14 providing an reference pulse to the controller 18, a flash memory storage module 10 having a plurality of flash memories 17a-17c and a flash memory controller 15 (see FIG. 2). The flash memories 17a-17c may be one of storage module chips (NAND Flash), a Secured Card (SD), a Multimedia Card (MMC), a Smart Media (SM), a Memory Stick (MS), a Compact Flash (CF) and an XD Picture Card. Besides, the flash memory storage module 10 may be replaced with a magnetic disk and a magnetic disk controller.

In use, when the 1394 physical layer 16 is inserted into a corresponding interface 3a of the host 3, the storage device 5 is electronically connected with the host 3. Then the controller 18 can receive write commands, read commands or erase commands from the host 3 through the 1394 physical layer 16, and write the data into the storage module 10, read or erase the data from the storage module 10 according to the commands.

For an IEEE 1394A, the storage device 5 in accordance with present invention can transfer differential signals TPA and TPB through the 1394 physical layer 16 and the interface 3a. The transfer rate of the differential signals TPA and TPB can be changed to 100 Mbit/sec, 200 Mbit/sec and 400 Mbit/sec according to different frequency combinations.

Furthermore, according to the IEEE 1394A, data is dual-transferred between the controller 18 and the 1394 physical layer 16 by 8-bits information signal DATA, and the applied width is determined according to the transfer speed of the package. For example, when the transfer rate is 100 Mbit/sec, 0-bits and 1-bits of the information signals DATA are adopted; when the transfer rate is 400 Mbit/sec, 0-bit to 7-bit of the information signals DATA are adopted. A 2-bit control signal (CTRL) is used to designate the communication status, such as idle, receive, and emit, between the controller 18 and the physical layer 16.

Link request (LREQ), link power status (LPS) and clock signal CLK are all 1-bit unidirectional signals. Wherein, the 1394 controller 18 accesses a temporary memory in the 1394 physical layer 16 by emitting the link request (LREQ). The 1394 controller 18 designates the power status thereof by emitting the link power status (LPS). When the LPS is in logic 0, it means that the 1394 controller 18 has no power, and the control signal (CTRL), information signal DATA and clock signal CLK are set to disable. When the clock signal (CLK) is at a frequency of 49.152 MHz, which is fed into the 1394 controller 18 from the 1394 physical layer 16, the link request (LREQ), the control signal (CTRL), and the information signal DATA between the 1394 controller 18 and the physical layer 16 are synchronized.

The above-mentioned IEEE 1394A is a 6-pin IEEE 1934A, but a 9-pin IEEE 1394B has also similar function. As for the IEEE 1394B currently introduced, its bandwidth is increased to 800 Mbit/s, 1600 Mbit/s or 3200 Mbit/s, and accordingly the control signal CTRL and the information signal DATA are increased. Then, the performance of a newer version IEEE 1394C can be predictable based on what is said above. The IEEE 1394A, IEEE 1394B and IEEE 1394C all belongs to standards of the IEEE.

The switch regulator 13 can be power supplied by the host 3 through the interface 3a. After boosting, bucking or inverting the power, the host provides power to the above-mentioned components for operation.

Switch regulation can be an inductance switch and a capacitive switch that is called Charge Pump. A general switch regulation is directed to the inductance switch.

As shown in FIG. 2, the flash memory storage module 10 in accordance with present invention further comprises an address line 21, a data line 22 and selection lines 24a-24c electrically connected with the corresponding flash memories 17a-17c, and the flash memory controller 15.

If to perform the write command, read command and erase command, and the data to be accessed being located in the first address of the flash memory 17b, the data can be accessed through the address line 21, the selection line 24b and the data line 22.

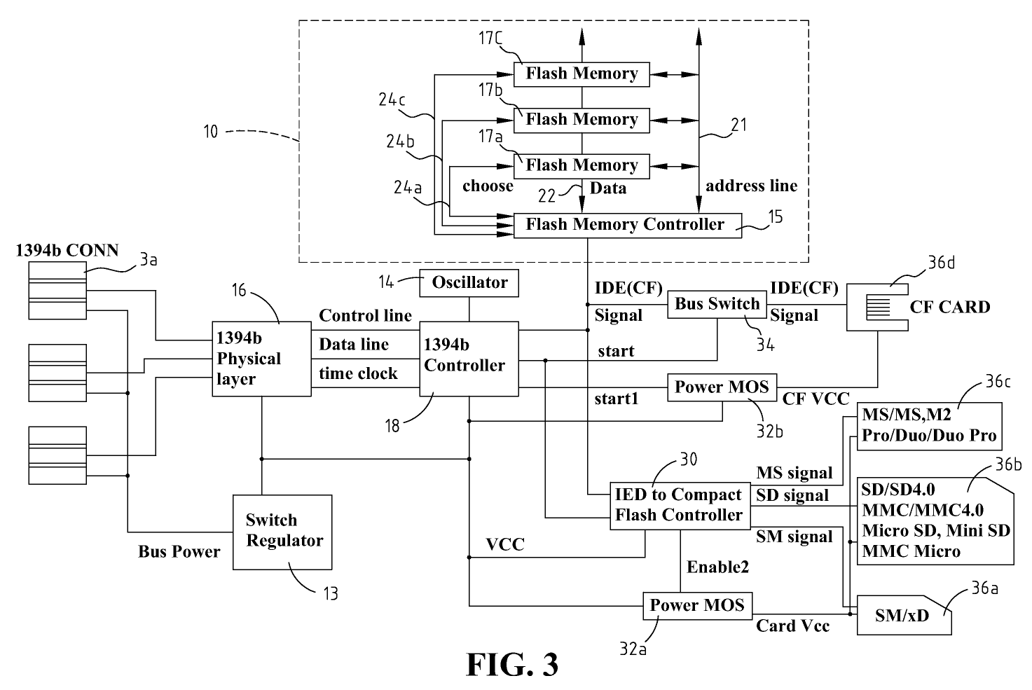

Referring to FIG. 3, a storage device 5 with a 1394 interface in accordance with another embodiment of present invention comprises an interface 3a, a switch regulator 13, an oscillator 14, a 1394 physical layer 16, a controller 18, and a flash memory storage module 10, wherein the flash memory storage module 10 can be replaced with other storage modules, or a Reader 36d can be provided behind the storage device 5, or Readers (not shown) can be provided between an IDE to compact flash controller 30 and memory cards 36a-36c. In case of adding the Readers, the Readers can be power supplied by the power MOS 32a and 32b. Under the control of the IDE to compact flash controller 30 and based on the bus switch 34, the data access on the memory cards 36a-36c can be performed. The Reader 36d can perform data access for the CF card or the IDE hard disk.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A storage device with a 1394 interface, which receives a command from a host to access data, comprising:
a 1394 physical layer electrically connected the storage device with the host after the 1394 physical layer is inserted into a corresponding interface of the host;
a storage module for storing data; and
a controller for receiving a write command, a read command or an erase command from the host through the 1394 physical layer, and according to the commands, writing the data into the storage module, or reading and erasing the data from the storage module.

2. The storage device with a 1394 interface as claimed in claim 1, wherein the storage module is composed of a flash memory controller and a flash memory, which is one of a NAND Flash, a Secured Digital (SD), a Multimedia Card (MMC), a Smart Media (SM), a Memory Stick, a Compact Flash (CF) and an XD Picture Card.

3. The storage device with a 1394 interface as claimed in claim 1, wherein the storage module is composed of a magnetic disk controller and a magnetic disk.
